(19) United States
(12) Patent Application Publication
(10) Pub. No.: US 2024/0104949 A1
(43) Pub. Date: Mar. 28, 2024

(54) ELECTRONIC COMPUTING DEVICE, AND IMAGE ANALYSIS METHOD AND COMPUTER PROGRAM PRODUCT THEREOF

(71) Applicant: inFlux Financial Technology Co. Ltd., Taipei City (TW)

(72) Inventor: Mu Chuang YAO, Taipei City (TW)

(21) Appl. No.: 18/238,120

(22) Filed: Aug. 25, 2023

(30) Foreign Application Priority Data
Aug. 26, 2022 (TW) 111132318

(51) Int. Cl. G06V 30/19; G06V 30/148; G06V 30/16; G06V 30/18

(52) U.S. Cl. CPC G06V 30/19093; G06V 30/153; G06V 30/16; G06V 30/18086

(57) ABSTRACT

An electronic computing device, and an image analysis method and a computer program product thereof are disclosed herein. The electronic computing device determines whether an image is a photograph, and when the image is a photograph, identifies at least one character block from the image, and divides the at least one character block into a plurality of sub-blocks. The electronic computing device further compares the similarity of the sub-blocks, and determines that the image data is a processed image if the number of times the similarity exceeds a similarity threshold reaches a count threshold.

### FIELD OF THE INVENTION

The present disclosure relates to an electronic computing device, and an image analysis method and a computer program product thereof. More specifically, the present disclosure relates to an electronic computing device for determining whether an image has been processed, and a method and a computer program product thereof.

### DESCRIPTIONS OF THE RELATED ART

In current document data auditing operation, in order to improve the processing efficiency and convenience of certification documents about the identity, academic experience, financial resources or the like of users, most organizations allow (or are planning to enable) users to directly copy the above certification documents into electronic files with their photographic devices (such as smart phones, digital cameras and other instruments), and use the electronic files as the certification documents they provide.

However, some unscrupulous people may use a pixel copying tool to tamper with other parts of a certification document on the basis of a certain part of the same certification document, thereby achieving the purpose of fraud. For example, users may use the pixel copy tool to tamper with numbers such as deposit and date in the financial certification documents, or tamper with names, degrees, names of departments and schools or other texts in the academic certification documents, with an attempt to mislead the devices or personnel in charge of auditing the certification documents; however, relying solely on human eyes or ordinary machine vision algorithms, usually we can only identify the contents of the images, but cannot successfully identify the processing marks in the images.

In view of the above situation, how to determine whether the image has been processed (for example, how to determine the image of a certification document forged by using the pixel copying tool) is an urgent technical problem to be solved in the art.

### SUMMARY OF THE INVENTION

In order to solve at least the above problems, the present invention provides an electronic computing device. The electronic computing device may comprise a storage and a processor electrically connected with the storage. The storage may be configured to store an image. The processor may be configured to determine whether the image is a photograph, and identify at least one character block from the image when it is determined that the image is a photograph, and divide the at least one character block into a plurality of sub-blocks. In addition, the processor is further configured to compare the similarity of the plurality of sub-blocks, and determine that the image is a processed image when the number of times the similarity exceeds a similarity threshold reaches a count threshold.

In order to solve at least the above problems, the present invention further provides an image analysis method. The image analysis method may comprise the following steps:
determining whether an image is a photograph by an electronic computing device;
identifying at least one character block from the image by the electronic computing device when it is determined that the image is a photograph;
dividing the at least one character block into a plurality of sub-blocks by the electronic computing device; and
comparing the similarity of the plurality of sub-blocks by the electronic computing device, and determining that the image is a processed image when the number of times the similarity exceeds a similarity threshold reaches a count threshold.

In order to solve at least the above problems, the present invention further provides a computer program product. The computer program product may execute the following instructions after being loaded into an electronic computing device:
determining whether an image is a photograph;
identifying at least one character block from the image when it is determined that the image is a photograph;
dividing the at least one character block into a plurality of sub-blocks; and
comparing the similarity of the plurality of sub-blocks, and determining that the image is a processed image when the number of times the similarity exceeds a similarity threshold reaches a count threshold.

To sum up, the electronic computing device and the image analysis method and the computer program product thereof provided according to the present disclosure divide character (including texts, numerals, markers, symbols, etc.) blocks in an image in detail, and determine whether the image is a processed image based on the similarity of the character blocks divided in detail. The principle lies in that: in a real image (i.e., a photograph) copied from a certification document with a photographic device, factors such as the position of the photographic device, the intensity of the light source, the position of the light source, and the relative position of the certification document with respect to the photographic device and the light source all substantially affect the imaging result of each pixel, which makes most of the pixels in the image actually shot with a photographic device are usually different in specific numerical expressions (e.g., image parameters such as illuminance and color temperature). In other words, in the real image copied from a document, two blocks that look the same to naked eyes (for example, blocks which are black on both the original document and the copied image) actually may have great differences in the numerical expression of various image parameters. Therefore, once the image content of a specific position (for example, the whole or part of a numeral) in the real copied image is used to tamper with the image content of other positions by using the pixel copying tool, there will be multiple positions with numerical expressions of excessively high similarity (even exactly the same) in the falsified image, that is, processing marks will be formed. The electronic computing device and the image analysis method and the computer program product thereof provided according to the present disclosure can effectively detect and count the number of positions suspected to be processing marks, and if the number exceeds the allowable error range, then it is determined that the image has been processed. Accordingly, the electronic computing device, the image analysis method thereof and the corresponding computer program product provided according to the present disclosure indeed solve the above problems in the art to which the present invention belongs.

The summary overall describes the core concept of the present invention, and covers problems that can be solved by the present invention, means that can be adopted by the present invention and effects that can be achieved by the present invention, so as to provide a basic understanding of the present invention by those of ordinary skill in the art to which the present invention belongs. However, it shall be appreciated that, the summary are not intended to summarize all embodiments of the present invention, but only present the core concept of the present invention in a simple form as an introduction to the detailed description that follows. Hereinafter, the detailed technology and implementation of the present invention will be described with reference to attached drawings, so that those of ordinary skill in the art to which the present invention belongs can understand the technical features claimed in the present invention.

### BRIEF DESCRIPTION OF THE DRAWINGS

FIG. 1 is a schematic view depicting an electronic computing device according to one or more embodiments of the present invention.

FIG. 2 is a flowchart diagram for determining whether an image has been processed according to one or more embodiments of the present invention.

FIG. 3 is a schematic view depicting an image divided into character blocks and sub-blocks according to one or more embodiments of the present invention.

FIG. 4 is a flowchart diagram depicting a method of identifying a processed image according to one or more embodiments of the present invention.

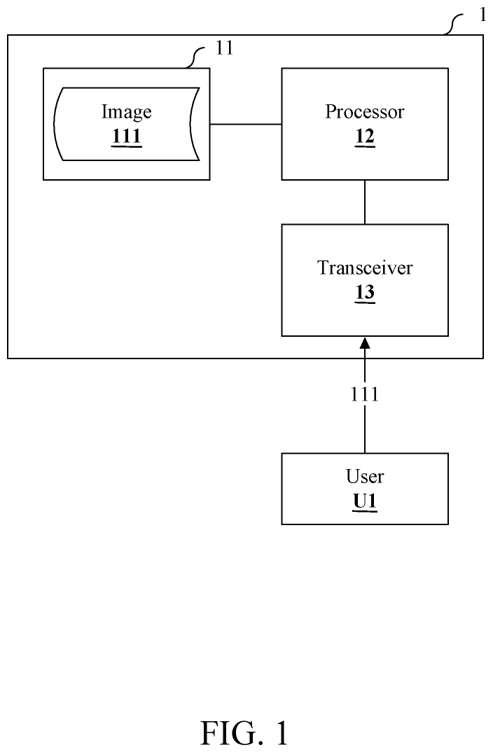

The contents shown in FIG. 1 to FIG. 4 are only exemplary examples for explaining the embodiments of the present invention, and are not intended to limit the scope claimed in the present invention.

### DESCRIPTION OF THE PREFERRED EMBODIMENT

Hereinafter, the electronic computing device and the image analysis method and the computer program product thereof provided according to the present invention will be explained through embodiments. However, these embodiments are not intended to limit the present invention to any environments, applications or implementations described in these embodiments. Therefore, description of these embodiments is only for purpose of explaining the present invention rather than for limiting the scope of the present invention. It shall be appreciated that, in the following embodiments and the attached drawings, elements unrelated to the present invention are omitted from depiction; and dimensions of and dimensional scales among individual elements are provided only for illustration, but not to limit the scope of the present invention.

Referring to FIG. 1, a first implementation of the present disclosure is an electronic computing device 1 for identifying whether an image has been processed. The electronic computing device 1 may basically comprise a storage 11 and a processor 12, and the storage 11 may be electrically connected with the processor 12. The electrical connection between the storage 11 and the processor 12 may be direct (i.e., the storage 11 and the processor 12 are connected to each other without using other elements) or indirect (i.e., the storage 11 and the processor 12 are connected to each other through other elements). The electronic computing device 1 may be one of various types of computing devices capable of image processing, such as but not limited to desktop computers, notebook computers, servers, mobile phones, and portable electronic accessories (watches, glasses and so on).

The storage 11 may be configured to store data generated by the electronic computing device 1, data introduced from external devices, or data input by a user U1 on his/her own. The storage 11 may comprise a primary memory (which is also called a main memory or an internal memory), and the processor 12 may directly read instruction sets stored in the primary memory, and execute these instruction sets if needed. The storage 11 may optionally comprise a secondary memory (which is also called an external memory or an auxiliary memory), and the memory at this level may transmit data stored to the primary memory through a data buffer. For example, the secondary memory may be but not limited to a hard disk, an optical disk or the like. The storage 11 may optionally comprise a third-level memory, i.e., a storage device that can be inserted into or pulled out from a computer directly, e.g., a mobile hard disk.

The storage 11 may be configured to store an image 111 (in the form of image data). The image 111 may correspond to various documents, such as but not limited to: identity certification documents, financial certification documents, academic certification documents, application forms or the like, and the image 111 may contain characters such as texts, numerals, markers, symbols or the like therein.

The processor 12 may be a microprocessor or a microcontroller or the like capable of signal processing. The microprocessor or the microcontroller is a kind of programmable specific integrated circuit that is capable of operating, storing, outputting/inputting or the like; moreover, the microprocessor or the microcontroller can receive and process various coded instructions, thereby performing various logical operations and arithmetical operations and outputting corresponding operation results. The processor 12 may be programmed to interpret various instructions so as to process data in the electronic computing device 1 and execute various operational programs or procedures.

In some embodiments, the electronic computing device 1 may further comprise a transceiver 13 electrically connected with the storage 11 and the processor 12. The transceiver 13 may comprise a transmitter and a receiver. Taking wireless communication as an example, the transceiver 13 may comprise, but not limited to, an antenna, an amplifier, a modulator, a demodulator, a detector, an analog-to-digital converter, a digital-to-analog converter and other communication elements. Taking wired communication as an example, the transceiver 13 may be for example, but not limited to, a gigabit Ethernet transceiver, a gigabit interface converter (GBIC), a small form-factor pluggable (SFP) transceiver, a ten gigabit small form-factor pluggable (XFP) transceiver or the like. In some embodiments, the user U1 may transmit the image 111 to the transceiver 13 through the network so as to store the image 111 in the storage 11.

In some embodiments, the electronic computing device 1 may further comprise an input module (not shown), and the user U1 may transmit the image 111 to the electronic computing device 1 through the input module so as to store the image 111 in the storage 11.

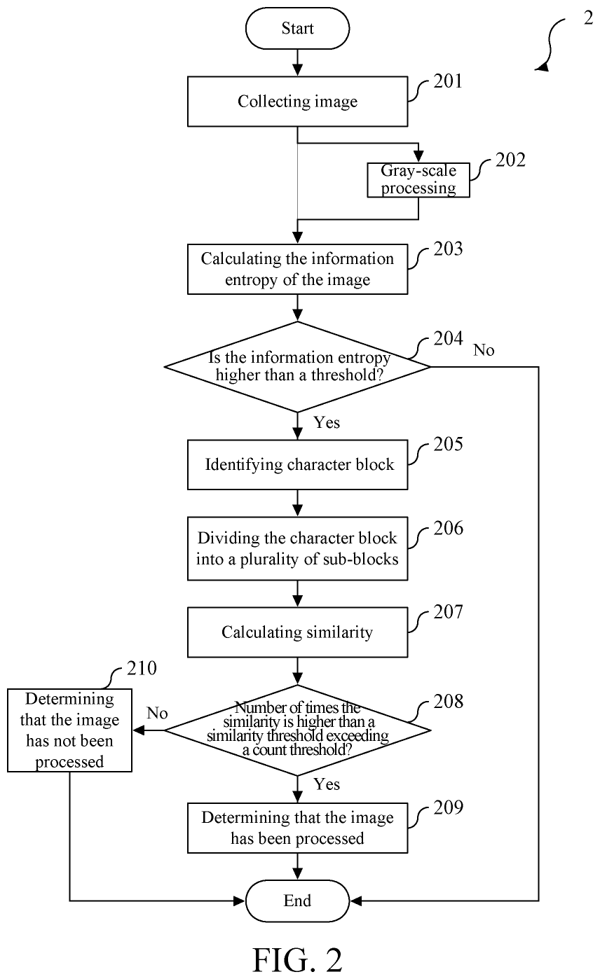

Referring to FIG. 1 and FIG. 2 together, a process flow 2 may be taken as an exemplary example for illustrating the details of determining by the electronic computing device 1 whether the image 111 has been processed. The process flow 2 may begin with an action 201. In the action 201, the electronic computing device 1 may first collect one or more images to be processed by the processor 12, such as the image 111.

Then, since the phenomenon that “two places that look the same to naked eyes actually have different numerical results” will only appear in a real photograph taken by a photographic device, the processor 12 may first identify whether each image is a real photograph directly taken by a photographic device before analyzing the similarity of the image (for example, the image 111).

For example, in some embodiments, the processor 12 may calculate the information entropy of the image 111 according to the Equation 1 shown below, and determine whether the image 111 is a real photograph according to the calculated information entropy (i.e., an action 203). For example, the information entropy may be calculated according to the Equation 1 shown below.

S=−Σᵢ₌₀²⁵⁵pᵢln(pᵢ) (Equation 1)

wherein “pᵢ” represents the occupancy ratio of pixels with gray scale level of “i” in the image.

In some embodiments, if necessary, then the processor 12 may also first execute for example the nearest neighbor interpolation method before calculating the information entropy of the image 111 so as to compress the image 111, for example, to a size of 100*100 pixels.

If the image 111 stored in the storage 11 is already a gray-scale image, then after the action 201, the action 203 may be directly performed. If the image 111 stored in the storage 11 is not a gray-scale image, then the processor 12 may first perform gray-scale processing on the image 111 (i.e., an action 202) after the action 201, and then perform the action 203.

After completing the action 203, an action 204 will be performed in turn. In the action 204, when the processor 12 determines that the information entropy calculated for the image 111 is higher than an information entropy threshold (which indicates that the uncertainty included in the image 111 is high enough), the processor 12 can confirm that the image 111 belongs to a real photograph. On the contrary, if the information entropy is lower than the information entropy threshold (which indicates that the image 111 may belong to a screenshot or a picture made by the computer, but not a real photograph), then the processor 12 can directly terminate the process flow 2 at this time. For example, the informa After confirming that the image 111 is a real photograph, an action 205 will be performed. In the action 205, the processor 12 may identify at least one character block in the image 111. For example, the processor 12 may identify one or more character blocks in the identified image 111 by executing an optical character recognition (OCR) algorithm (e.g., Google Vision OCR). Next, in an action 206, the processor 12 may further divide the one or more character blocks into a plurality of sub-blocks.

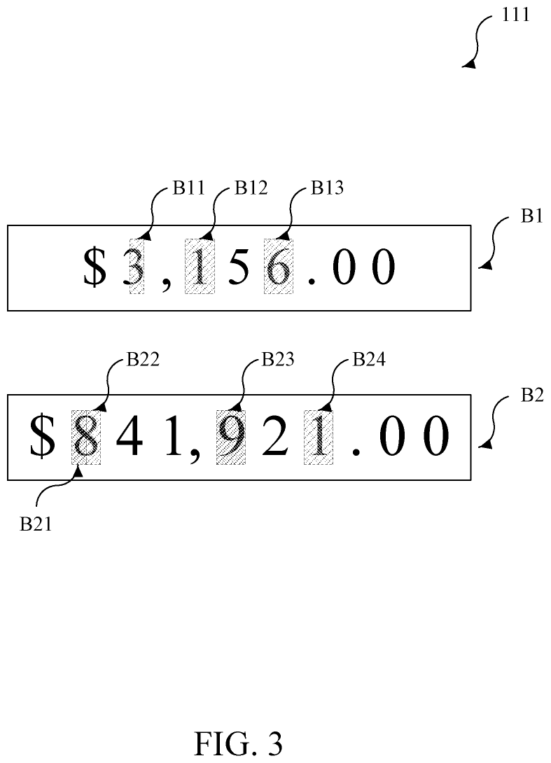

Referring to FIG. 2 and FIG. 3 together, it is assumed that the image 111 is an image copied from a bankbook by a photographic device, and the processor 12 has identified a character block B1 and a character block B2 which contain capital amount in the image 111, and divided a plurality of sub-blocks B11-B13 in the character block B1 and divided a plurality of sub-blocks B21-B24 in the character block B2, as shown in the dotted box in FIG. 3.

Since the forger may forge on the basis of one or more complete characters in the same image, or forge only on the basis of a part of a single character, the scope of each sub-block may cover the whole character (as shown by the sub-blocks B12-B13 and the sub-blocks B23-B24) or only cover a part of the character (as shown by the sub-block B11 and the sub-blocks B21-B22).

It should be noted that the number, size and position of the dashed boxes (i.e., sub-blocks) shown in FIG. 3 are only set in such a manner for convenience of description. Therefore, in some embodiments, in order to successfully cover all possible processing marks, the plurality of sub-blocks divided by the processor 12 from all the identified character blocks may completely cover all the characters in the image 111.

After completing the action 205, an action 206 will be performed in turn. In the action 206, the processor 12 may calculate the similarity between the plurality of sub-blocks. The way in which the processor 12 calculates the similarity may be performed through for example, but not limited to, the “matchTemplate” function in OpenCV (such as the TM_CCOEFF_NORMED template matching mode therein) or other image comparison methods based on object recognition.

In some embodiments, the processor 12 compares the similarity of two sub-blocks among the plurality of sub-blocks every time, and increases the number of times of abnormal similarity whenever the similarity between the two sub-blocks is higher than a similarity threshold. Then, the processor 12 determines whether the number of times of abnormal similarity is higher than a count threshold (i.e., an action 208). If the number of times of abnormal similarity is higher than the count threshold, then it means that positions suspected to be processing marks in the image 111 have exceeded the allowable error range, and thus the processor 12 can accordingly determine that the image 111 is a processed image (i.e., an action 209). On the contrary, if the number of times of abnormal similarity is not higher than the count threshold, then the processor 12 will determine that the image 111 has not been processed (i.e., an action 210). For example, the similarity threshold described above may be 0.99, and the count threshold may be 5 times.

For example, in the example of FIG. 3, the processor 12 may detect that the similarity between the sub-block B12 and the sub-block B24 is higher than the similarity threshold after calculating the similarity between the sub-blocks, and accordingly determine that the similarity between the sub-block B12 and the sub-block B24 is an abnormal similarity, and increase the number of times of abnormal similarity by one.

In addition, in some embodiments, the processor 12 may also try to perform rotation and minoring or other processing on each of the sub-blocks first so as to calculate the similarity more comprehensively. For example, the processor 12 may rotate the sub-block B13 by 180 degrees (i.e., flip the sub-block B13 vertically), and accordingly calculate that the similarity between the sub-block B23 and the sub-block B13 is higher than the similarity threshold, and then further increase the number of times of abnormal similarity by one. The processor 12 may also perform mirroring processing on the sub-block B11 and/or the sub-block B22, and calculate that not only the similarity between the sub-block B11 and the sub-block B22 is higher than the similarity threshold, but also the similarity among all of the sub-block B11, the sub-block B21 and the sub-block B22 is higher than the similarity threshold, thereby increasing the number of times of abnormal similarity by three. In other words, the position of the numeral “8” in the character block B2 may have been the numeral “3” originally, but it was changed to the numeral “8” by the forger through performing covering and minoring based on the sub-block B11.

In view of the fact that the contents of characters included in the sub-blocks may be greatly different from each other (for example, one sub-block contains one complete character, while the other sub-block only contains a part accounting for 5% of a single character), the benefit of calculating the similarity between the sub-blocks in this case may be unsatisfactory. Therefore, in some embodiments, the processor 12 may record the characters corresponding to the contents in each of the sub-blocks when divides the sub-blocks, so that in the subsequent calculation of similarity, the processor 12 may only calculate the similarity for each group of sub-blocks with the same characters, thereby saving computing resources.

Similarly, in some embodiments, in addition to recording the characters corresponding to each of the sub-blocks, the processor 12 may also further define the approximate relationships between various types of characters (i.e., other characters which are similar to each other in appearance, such as the numeral 3 vs. the numeral 8, the numeral 6 vs. the numeral 9, the numeral 5 vs. the English letter S and so on), so that in the subsequent calculation of similarity, the processor 12 may calculate the similarity not only for the sub-blocks corresponding to the same characters, but also for the sub-blocks corresponding to the similar characters.

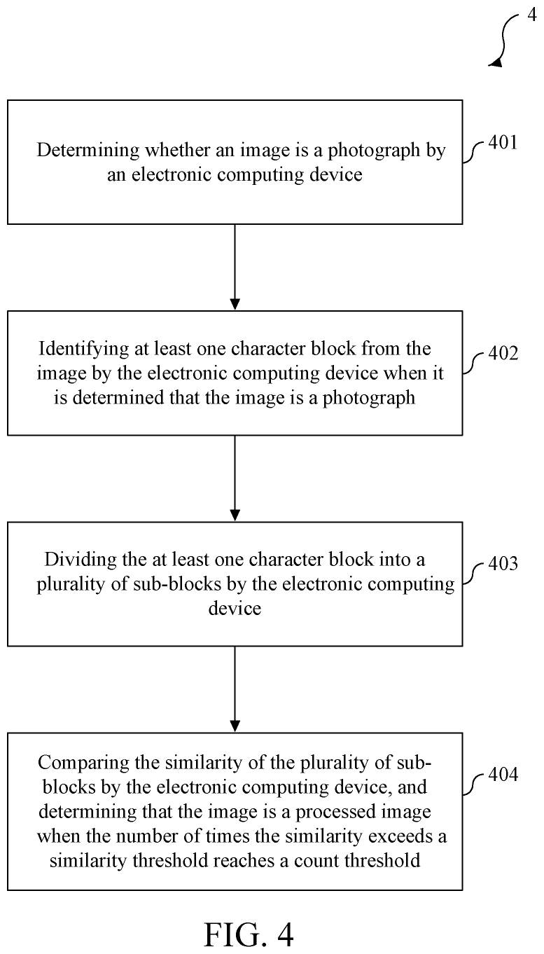

Referring to FIG. 4, a second implementation of the present disclosure is an image analysis method 4. The image analysis method 4 may comprise the following steps:
determining whether an image is a photograph by an electronic computing device; (labeled as 401)
identifying at least one character block from the image by the electronic computing device when it is determined that the image is a photograph (labeled as 402);
dividing the at least one character block into a plurality of sub-blocks by the electronic computing device (labeled as 403); and
comparing the similarity of the plurality of sub-blocks by the electronic computing device, and determining that the image is a processed image when the number of times the similarity exceeds a similarity threshold reaches a count threshold (labeled as 404).

In some embodiments, the image analysis method 4 may further comprise the following step:
calculating an information entropy of the image by the electronic computing device; and
determining that the image is a photograph when the information entropy is higher than an information entropy threshold.

In some embodiments, the image analysis method 4 may further comprise the following step:
performing gray-scale processing on the image by the electronic computing device before calculating the information entropy;
wherein the electronic computing device calculates the information entropy according to the gray scale level of the image.

In some embodiments, the image analysis method 4 may further comprise the following step:
determining characters included in each of the plurality of sub-blocks by the electronic computing device;
wherein the electronic computing device performs similarity comparison on each group of sub-blocks containing the same characters.

Each embodiment of the image analysis method 4 basically corresponds to a certain embodiment of the electronic computing device 1. Therefore, all the corresponding embodiments of the image analysis method 4 can be fully appreciated and realized by those of ordinary skill in the art to which the present invention belongs simply with reference to the above description of the electronic computing device 1, even though each embodiment of the image analysis method 4 is not described in detail separately in the above description.

A third implementation of the present disclosure is a computer program product implemented according to the image analysis method 4 in the second implementation. When the computer program product is read into an electronic computing device, the electronic computing device executes the corresponding steps of each embodiment of the image analysis method 4 described in the second implementation. The computer program product refers to an article that carries a computer-readable program and is not limited in external forms, such as but not limited to: a non-transitory tangible machine-readable medium, for example (but not limited to) a read-only memory (ROM), a flash memory, a floppy disk, a mobile hard disk, a magnetic tape, a network database, a cloud node, or any other computer software storage medium with the same function and well known to those of ordinary skill in the art to which the present invention belongs.

The above implementations are only used to illustrate part of embodiments of the present invention and explain the technical features of the present invention, the scope of protection of the present invention is not limited thereto. Any modifications or equivalence arrangements that can be easily accomplished by people with ordinary skill in the art to which the present invention belongs should be covered by the scope claimed in the present invention, and the scope of rights protection of the present invention shall be subject to the claims as appended.

### BRIEF DESCRIPTION OF REFERENCE NUMERALS

1: electronic computing device
11: storage
111: image
12: processor
13: transceiver
2: process flow
201-210: action
4: image analysis method
401-404: step
U1:user
B1, B2: character block
B11-B14, B21-B24: sub-blocks

What is claimed is:

1. An electronic computing device, comprising:
a storage, being configured to store an image; and
a processor, being electrically connected with the storage and being configured to:
determine whether the image is a photograph;
identify at least one character block from the image when it is determined that the image is a photograph;
divide the at least one character block into a plurality of sub-blocks; and
compare the similarity of the plurality of sub-blocks, and determine that the image is a processed image when the number of times the similarity exceeds a similarity threshold reaches a count threshold.

2. The electronic computing device according to claim 1, wherein the processor is further configured to:
calculate an information entropy of the image; and
determine that the image is a photograph when the information entropy is higher than an information entropy threshold.

3. The electronic computing device according to claim 2, wherein before calculating the information entropy, the processor is further configured to perform gray-scale processing on the image, and the processor calculates the information entropy according to the gray-scale level of the image.

4. The electronic computing device according to claim 1, wherein the processor is further configured to determine characters included in each of the plurality of sub-blocks, and the processor performs similarity comparison on each group of sub-blocks containing the same characters.

5. An image analysis method, comprising the following steps:
determining whether an image is a photograph by an electronic computing device;
identifying at least one character block from the image by the electronic computing device when it is determined that the image is a photograph;
dividing the at least one character block into a plurality of sub-blocks by the electronic computing device; and
comparing the similarity of the plurality of sub-blocks by the electronic computing device, and determining that the image is a processed image when the number of times the similarity exceeds a similarity threshold reaches a count threshold.

6. The image analysis method according to claim 5, further comprising the following steps:
calculating an information entropy of the image by the electronic computing device; and
determining that the image is a photograph when the information entropy is higher than an information entropy threshold.

7. The image analysis method according to claim 6, further comprising the following step:
performing gray-scale processing on the image by the electronic computing device before calculating the information entropy;
wherein the electronic computing device calculates the information entropy according to the gray scale level of the image.

8. The image analysis method according to claim 5, further comprising the following step:
determining characters included in each of the plurality of sub-blocks by the electronic computing device;
wherein the electronic computing device performs similarity comparison on each group of sub-blocks containing the same characters.

9. A computer program product, executing the following instructions after being loaded into an electronic computing device:
determining whether an image is a photograph;
identifying at least one character block from the image when it is determined that the image is a photograph;
dividing the at least one character block into a plurality of sub-blocks; and
comparing the similarity of the plurality of sub-blocks, and determining that the image is a processed image when the number of times the similarity exceeds a similarity threshold reaches a count threshold.

10. The computer program product according to claim 9, further executing the following instructions after being loaded into the electronic computing device:
calculating an information entropy of the image; and
determining that the image is a photograph when the information entropy is higher than an information entropy threshold.

11. The computer program product according to claim 10, further executing the following instruction after being loaded into the electronic computing device:
performing gray-scale processing on the image;
wherein the electronic computing device calculates the information entropy according to the gray scale level of the image.

12. The computer program product according to claim 9, further executing the following instruction after being loaded into the electronic computing device:
determining characters included in each of the plurality of sub-blocks;
wherein the electronic computing device performs similarity comparison on each group of sub-blocks containing the same characters.
